(19) United States
(12) Patent Application Publication
(10) Pub. No.: US 2007/0063173 A1
(43) Pub. Date: Mar. 22, 2007

(54) ERGONOMIC HOIST AND METHOD

(75) Inventors: Zachary P. Fijal, Brookfield, IL (US); Jeffrey Schueller, Streamwood, IL (US); Sanjay Patel, Bartlett, IL (US); Andrew F. Filipiak, Gurnee, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC

(21) Appl. No.: 11/423,790

(22) Filed: Jun. 13, 2006

Related U.S. Application Data
(60) Provisional application No. 60/697,022, filed on Jul. 6, 2005.

(51) Int. Cl. B66D 1/48

(52) U.S. Cl. 254/267

(57) ABSTRACT

An ergonomic hoist (100) includes a lift assembly (111) riding on a support (105). A load support assembly (127) is connected to the lift assembly (111) through a lift arm (121). An operator panel (145) is connected to the support assembly (127) through a support arm (137). The operator panel (145) is maintained at substantially the same height when the support assembly (127) moves, including movement in a vertical direction.

### CLAIM OF PRIORITY

This application claims the priority benefit of the filing date of Provisional Application No. 60/697,022 filed Jul. 6, 2005, on behalf of the same inventors as the present application and assigned to the assignee hereof.

### FIELD OF THE INVENTION

This invention relates to transferring loads between different positions in a manufacturing environment, including but not limited to ergonomically transferring engines between assembly stations.

### BACKGROUND OF THE INVENTION

Assembly processes often require an operator to transfer a heavy load from one assembly station to another. Sometimes, one or both assembly stations are located on conveyors, making the transfer of the load from one conveyor to another more challenging. Even though various types of cranes and hoists have been used to transfer these loads, the process of lifting the load from a moving conveyor and aligning it for deposition onto another conveyor has been time consuming.

Engine assembly plants are examples of processes requiring handling of heavy loads. Internal combustion engines often weigh upwards of 400 kg and may require handling for transfer between assembly stations in the plant and transfer from a conveyor to a vehicle for installation. The transfer of engines by an operator in the plant using overhead cranes or hoists is time consuming and sometimes complicated.

Cranes and hoists used for transferring engines in an assembly plant may utilize electrically driven winches operated by a hand-held push button pad. An operator often stands in one spot holding the push button pad in one hand and manipulates the crane in place over the engine to make a connection. The operator may connect a crane to the engine using a cable, then lifts the engine from a first location, pushes the crane with the engine attached to a second location, and lowers the engine in place before disconnecting it from the crane. The time required for this type of process may be considerable.

Accordingly, there is a need for a system for manipulating heavy loads in a manufacturing environment that is more time efficient.

### SUMMARY OF THE INVENTION

A hoist includes a lift assembly disposed on a support and a lift arm disposed between the lift assembly and a support assembly. A support arm is disposed between the support assembly and an operator panel that is maintained at substantially the same height when the support assembly moves in a vertical direction.

A method for utilizing a hoist includes positioning the hoist over a load at a first position and lowering the hoist to a first position while maintaining an operator panel at substantially a first height. The load is attached to the hoist. The hoist is raised to a second position while maintaining the operator panel at substantially the first height. The hoist moves while carrying the load to a third position. The hoist is lowered at the third position while maintaining the operator panel at substantially the first height.

### BRIEF DESCRIPTION OF THE DRAWINGS

FIG. 1 is a side view of an ergonomic hoist system in accordance with the invention.

FIG. 2 is a side view of an ergonomic hoist system carrying a load in accordance with the invention.

FIG. 3A and FIG. 3B are side views of an ergonomic hoist system in two different positions in accordance with the invention.

FIG. 4 is a front view of an operator panel for a hoist system in accordance with the invention.

FIG. 5A and FIG. 5B are perspective views of operator handles with control switches for a hoist system in accordance with the invention.

FIG. 6 is a flowchart for a method of transporting a load using a hoist system in accordance with the invention.

FIG. 7A is a perspective view of a known hoist and operator.

FIG. 7B is a perspective view of operator handles for the known hoist.

### DESCRIPTION OF A PREFERRED EMBODIMENT

The following describes an apparatus for and method of efficiently and ergonomically manipulating loads, such as internal combustion engines, in a manufacturing environment. This apparatus advantageously makes the transfer of engines from one location to another in a time efficient manner that is safe for the operator. The apparatus may be used, for example, to transfer internal combustion engines that may weigh, for example, over 400 kg. Hundreds of these engines may need to be transferred from one moving conveyor system onto another 500 times or more during a typical shift. A method for controlling this apparatus is also disclosed, with intuitive controls for positioning a hoist accurately over a loading and an unloading position, even if both positions are located on moving conveyor systems.

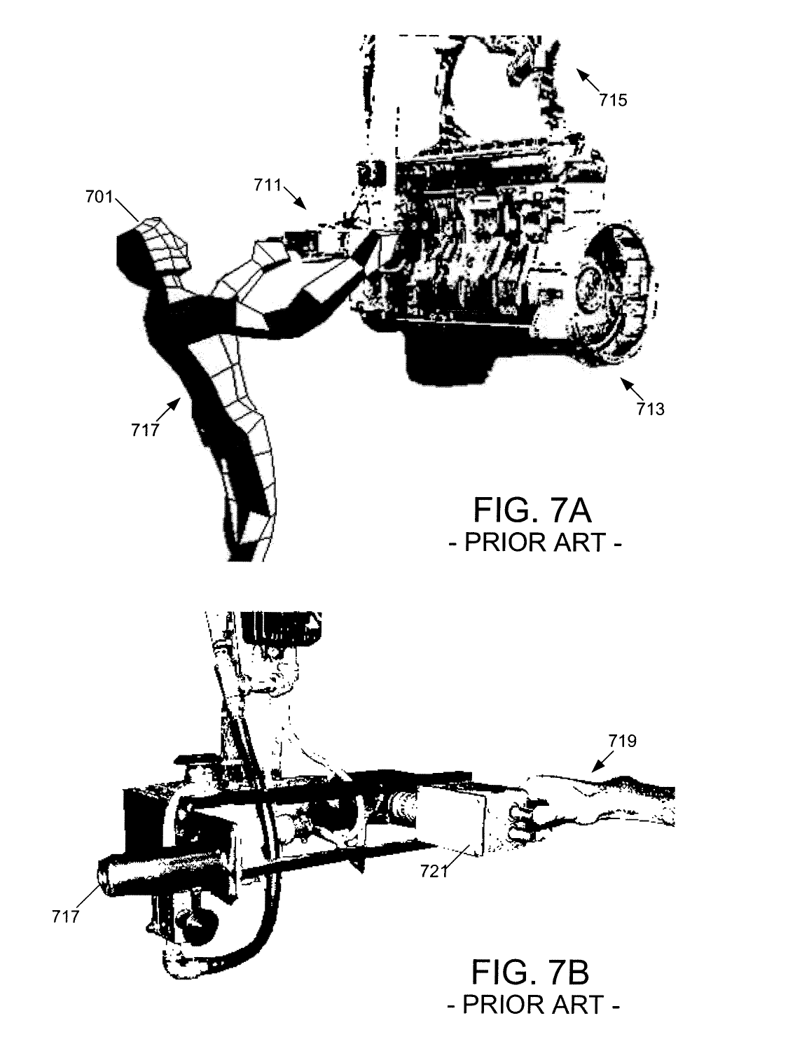

A known hoist is shown in FIG. 7A and FIG. 7B. In FIG. 7A, an operator 701 holds a pair of handles 711 with both hands as he lifts an engine 713 using a hoist 715. The handles 711 are attached to the hoist 715. As the hoist 715 is raised, the handles 711 are raised with it and force the operator 701 to extend both arms upward. The handles 711 may reach a height of 62 in (1.58 m) maximum, which may be a long reach for some individuals. This operator 701 may need to move his/her arms to move the handles 711 a large number of times during the day, which may be tiring. The hoist 715 is not capable of powered motion in any horizontal direction. The operator's hand 719 is shown holding one of the handles 711 in FIG. 7B. A set of control switches 721 is located adjacent to the handle 711. The operator 701 actuates the switches with the thumb on the operator's hand 719.

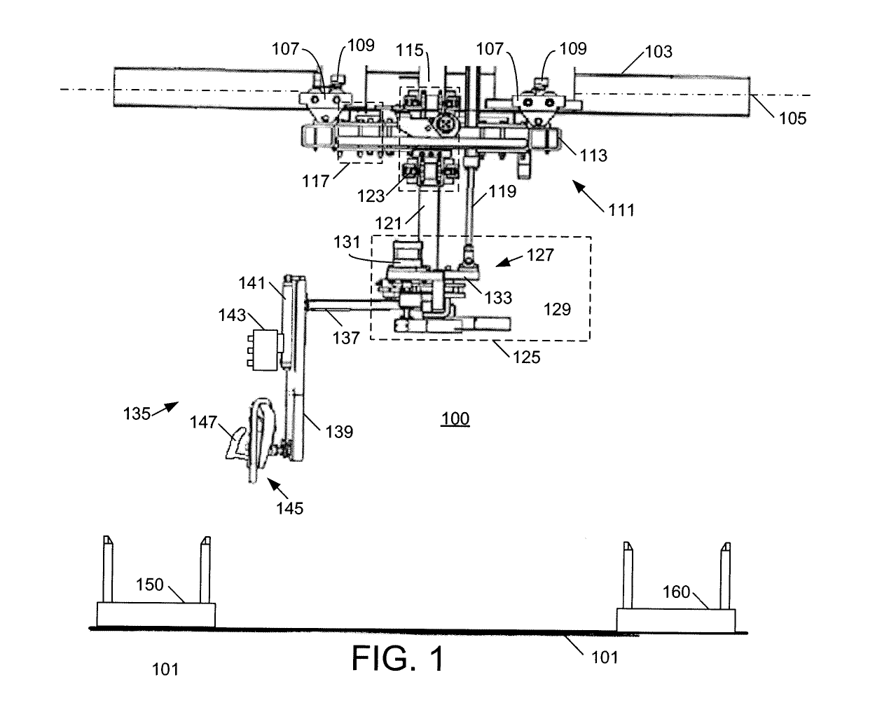

A new and improved hoist 100 installed, for example, in an assembly plant, is shown in FIG. 1. The assembly plant includes a floor 101 and a horizontal support 103. The horizontal support 103 may be a structural part of the plant or may be installed as a support for the hoist 100. The horizontal support 103 may advantageously include an “I” beam that facilitates motion of the hoist 100 along a major axis 105, such as a horizontal axis. The horizontal support 103 is advantageously located above the operator's head. The hoist 100 has one or more roller assemblies 107 that move along and secure to the horizontal support 103. Each roller assembly 107 may be powered by an electric driver 109 that provides powered motion to the hoist 100. The powered motion may be controlled by an operator and/or an automated positioning system. For hoist 100s carrying small enough loads, the roller assemblies need not be powered or driven, for example, when the force needed to manipulate the hoist 100 is low enough for an individual to repeatedly provide without undue strain and/or when the force falls within recommended ergonomic ranges.

The hoist includes a lift assembly 111. The lift assembly 111 is connected to the rollers 107 and includes, for example, a structural frame 113, a load assembly 115, and an electronic module 117. The structural frame 113 has any configuration adequate to support the weight of the hoist 100 and its load as they move. A weight limit for the load on the lift assembly 111 may be, for example, 2,500 kg, but other designs having lower or higher weight limits may be used based on the nature and/or magnitude of the load of each application. The load assembly 115 includes a lift piston 119, a lift arm 121, a vertical guide assembly 123, a vertical position sensor (not shown), and a vertical brake (not shown). The lift piston 119 lifts and lowers a support assembly 125 and may be pneumatically, hydraulically, or mechanically driven. The support assembly 125 is connected to the lift assembly 111 through the lift piston 119 and the lift arm 121. The vertical guide assembly 123 ensures an axial motion of the support assembly 125 with respect to the lift assembly 111 under the force of the lift piston 119. The vertical position sensor is connected to the electronic module 117. The electronic module 117 is connected to the vertical brake, which is may be electrically controlled. The vertical brake is capable of stopping and holding the lift arm 121 with respect to the vertical guide assembly 123.

The support assembly 125 includes an upper support 127, and a lower support 129. The upper support 127 includes an angular position motor 131 and a support plate 133. The support plate 133 is shown connected to the lift arm 121 and the lift piston 119. The angular position motor 131 is attached to the support plate 133. The lower support 129 is shown rotateably attached to the support plate 133 and is capable of rotating with respect to the lift assembly 111 under the action of the angular position motor 131. The angular position motor is electronically connected to the electronic module 117 and may be pneumatically, hydraulically, or mechanically driven. A rotational position sensor (not shown) is disposed between the support plate 133 and the lower support 129 and is also electronically connected to the electronic module 117. The angular position motor 131 is capable of stopping the lower support 129 and maintaining it at an angular position with respect to the support plate 133. Alternatively, a rotational position brake may also be used and connected between the support plate 133 and the lower support 129 to stop rotational motion and maintain a rotational position. In the case where a rotational position brake is used, the rotational position brake may be electronically controlled and may be connected to and controlled by the electronic module 117. The hoist 100 may use electric motors having variable frequency drive (VFD) capability for motion of the hoist 100. VFD may be used to allow for variable hoist 100 speed in horizontal and/or vertical direction(s).

An operator assembly 135 is connected to the support assembly 125 through a support arm 137. The support arm 137 is free to rotate about the same axis as the engine support 129 with respect to the support plate 133. Alternatively, the support arm 137 may be rigidly connected to the lower support 129 or the support plate 133, or it may be free to rotate about an axis different from the axis of rotation of the lower support 129. The operator assembly 135 is connected on an end of the support arm 137 opposite the connection to the support assembly 125. The operator assembly 135 includes a frame 139, an adjustment piston 141, an control interface 143, an operator panel 145, and operator handles 147.

The frame 139 is slideably connected to the support arm 137. A height adjustment mechanism (not shown) is capable of adjusting the relative position of the support arm 137 to the frame 139. The control interface 143 is mounted on the frame 139 and includes a plurality of electronic switches and displays (not shown) that provide an interface between a human operator and the electronic module 117 for exchange of information and commands. The adjustment piston 141 may be hydraulically, pneumatically, or mechanically driven, and is shown connected between the frame 139 and the operator panel 145. The operator panel 145 is advantageously slideably connected to the frame 139. The position of the operator panel 145 relative to the frame 139 is controlled by the adjustment piston 141.

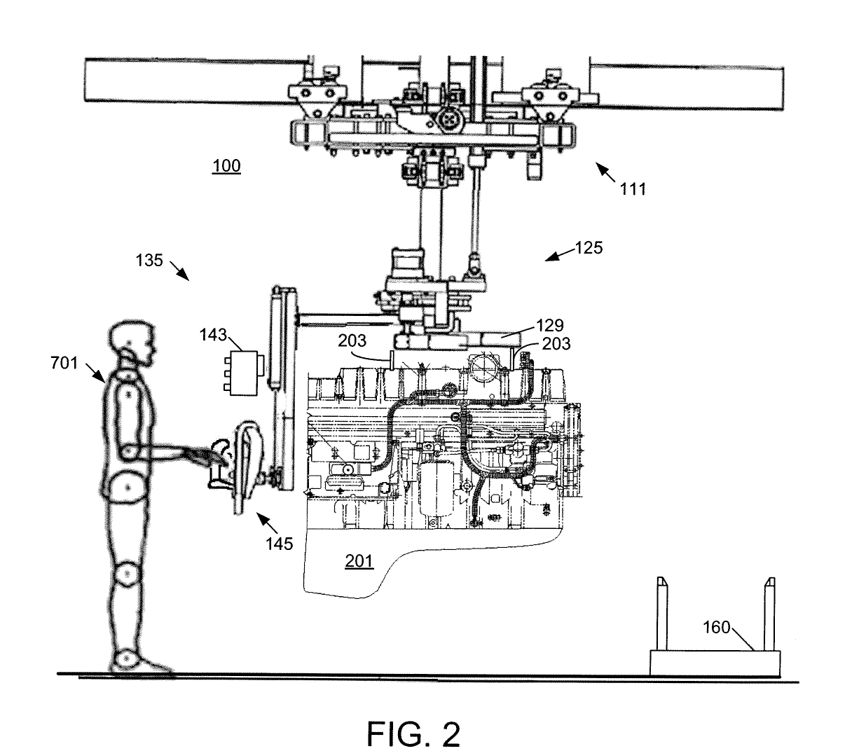

The operator handles 147 are connected to the operator panel 145. The handles 147 include a number of switches (not shown) that enable the operator to control the position, orientation, and operation of the hoist 100. In one possible operating environment, the hoist 100 may be used to transport a load, for example, from a first conveyor line 150 to a second conveyor line 160. An operator 701 stands next to the operator panel 145 and holds the handles 147 as shown in FIG. 2. An engine 201 is shown as an illustration of a load attached to and transported by the hoist 100. The engine 201 is connected to the support assembly 125 through the lower support 129. Engines typically have lifting eyes 203 that are plates attached to the engine and have holes through which the engine is engaged and lifted. The lower support 129 may have a set of retractable rams (not shown) that are operated by a switch (not shown) in the handles 147. The rams may be extended through holes in the lifting eyes 203 to hold the engine 201 to the lower support 129 during transport.

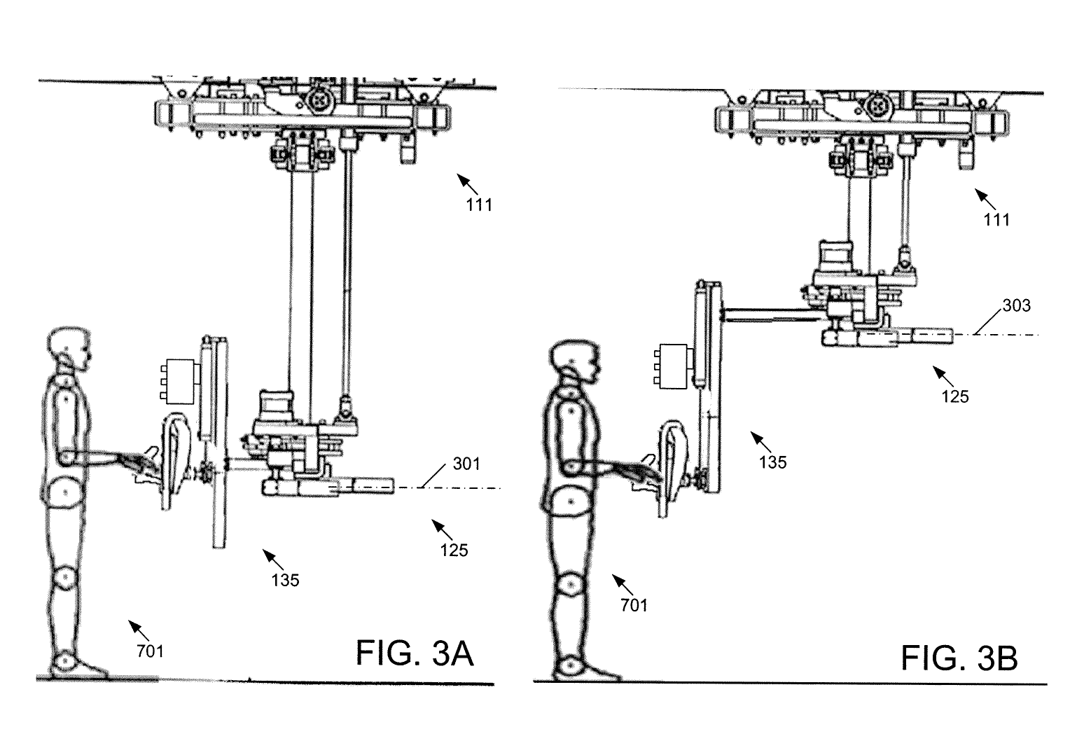

One advantage of the hoist 100 is its ability to maintain an ergonomic and comfortable position for the operator panel 145 relative to the operator 701 during operation. As shown in FIG. 3A, when the support assembly 125 is at an extended or low position 301, the lift piston 119 is extended, the lift arm 121 is extended, the support arm 137 is positioned low on the frame 139 of the operator assembly 135, and the adjustment piston 141 is retracted to keep the control interface 143 and the operator panel 145 at a height that is comfortable for the operator 701. The support assembly 125 is shown in a retracted or lift position 303 in FIG. 3B. When in the lift position 303, the lift piston 119 is retracted, the lift arm 121 is retracted, the support arm 137 is positioned high on the frame 139 of the operator assembly 135, and the adjustment piston 141 is extended to maintain the control interface 143 and the operator panel 145 at substantially the same height as shown in FIG. 3A for the operator 701.

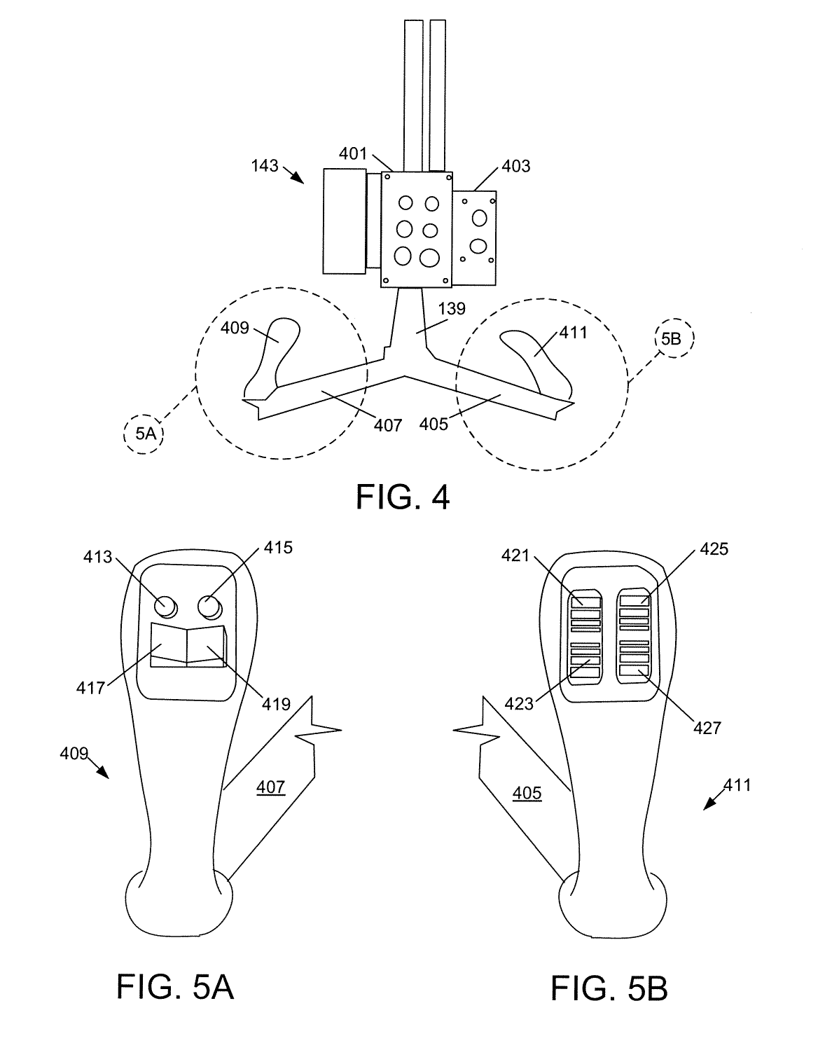

A front view of the operator panel 145, as may be seen from the perspective of the operator 701, is shown in FIG. 4. The control interface 143 includes a main interface 401 and a master switch 403. A right handle support 405 and a left handle support 407 are connected to the frame 139. The left handle support 407 has a left handle 409 attached at or near one end. The right handle support 407 has a right handle 411 attached at or near one end. The handles 409 and 411 are shown in detail in FIG. 5A and FIG. 5B.

The left handle 409 as shown in FIG. 5A includes switches actuatable by the left hand of the operator 701. A first button 413 may be actuated by the thumb of the operator 701, for example, to grip the load 201, for example, by actuating the rams on the lower support 129. A second button 415 may also be actuated by the thumb of the operator 701, for example, to release the load 201, for example, by retracting the rams on the lower support 129. A third button 417 and fourth button 419 may be pressed to move the hoist 100 in two different horizontal directions, for example north and south. The third button 417 and fourth button 419, or any of the other buttons on either handle, may be part of a single dual-position switch. Operations requiring thumb actuation of switches require less force and are conducive to more comfortable operation.

The right handle 411 shown in FIG. 5B includes switches actuatable by the right hand of the operator 701. A fifth and sixth buttons 421 and 423 may be pressed to move the hoist 100 in two different vertical directions, for example up and down. A seventh and eighth buttons 425 and 427 may be pressed to move the hoist 100 in two horizontal directions, for example east and west.

The left handle 409 and/or right handle 411 may have one or more dead-man switches 429 located such that when the operator grips the handle(s), his/her palm presses in the dead-man switch(es) 429. Alternatively, the dead-man switch 429 may be located on the far side (not shown) of either handle 409 or 411, and may be pressed in by one or more of the operator's 701 fingers when gripping either or both handles 409 or 411. When the dead-man switch 429 is released when the operator lets go of the handle(s) 409 and/or 411, the hoist 100 automatically stops and/or provides any other desired function when the dead-man switch 429 is released. Each of the handles 409 and 411 may advantageously be ergonomically shaped for ease of operation, and have various switches used often be disposed close to the operator's fingers. Moreover, many of the controls on the handles may be arranged for “one time activation”, i.e., activation of a feature, for example engagement and retention of a load, may be accomplished by a single push of a button rather than a continuous depression of the button.

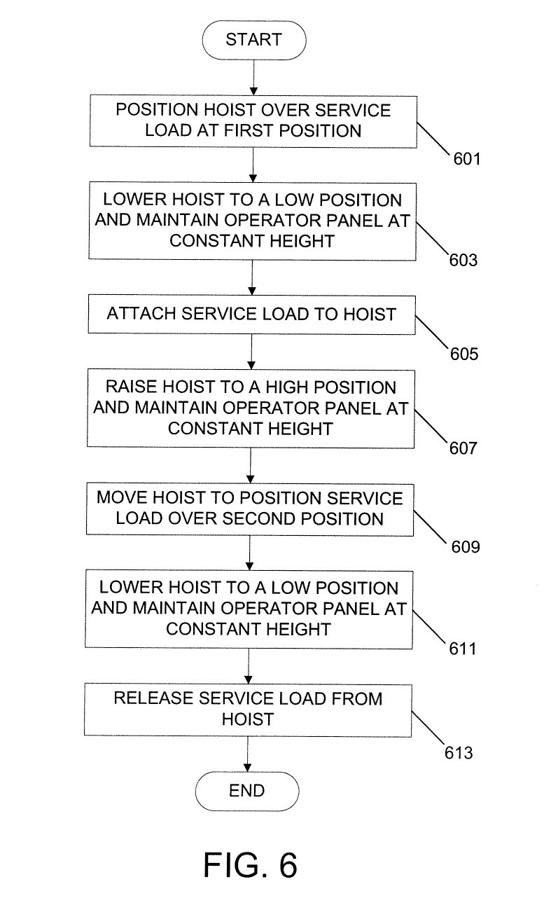

A method for transporting a load using a hoist 100 is shown in FIG. 6. At step 601, the hoist 100 is positioned over a first position, such as a first conveyor belt holding the load 201. The hoist 100 may advantageously automatically compensate for motion of the load, for example, when the first position of the load is on a moving conveyor system. The hoist 100 is lowered at step 603 to a low position over the load 201, while maintaining the operator panel 145 at substantially the same height throughout the process of moving the load 201.

The load 201 is attached to or gripped by the hoist 100 at step 605. The hoist 100 is raised to a high position at step 607, which high position is vertically higher than the low position of step 603, while moving the load 201 and maintaining the operator panel 145 at substantially the same height. The hoist 100 is moved to position the load 201 over a second position at step 609. The hoist 100 may advantageously be capable of moving to another position that lies past the first position to allow for manufacturing flexibility if, for example, a load lying on the conveyor system is deemed defective, or incomplete, and requires removal to a secondary conveyor system for rework. The hoist 100 may be advantageously capable of automatically compensating for motion, for example, when the second position is on a moving conveyor system. The load 201 is lowered and deposited onto the second position at step 611 while maintaining the operator panel 145 at the substantially the same height throughout the process of moving the load 201. The load 201 is released from the hoist 100 at step 613. The motion of the hoist 100 may include one or more horizontal directions and/or one or more vertical directions as needed to located the hoist 100 throughout the process.

Throughout the process of moving the load 201, e.g., from step 601 through step 613, the operator panel 145 is advantageously maintained at substantially the same height from the floor 101. Maintaining substantially the same height within a relatively narrow range provides the advantage of ergonomic operation by the hoist 100. For example, the operator need not reach or bend in ways that may stress the arms or lower back. Although the relatively narrow range may be within 6 to 8 inches (15 to 20 cm) of a chosen height of the operator panel 145, other larger and smaller ranges may be utilized, for example, to accommodate taller or shorter individuals or to facilitate other comfort ranges, and/or to meet suggested guidelines for ergonomic operation of equipment. For example, the operator panel 145 may be maintained 36 in (0.91 m) to 48 in (1.22 m) from the handles 147 to the floor 101. The height of the operator panel 145 may alternatively move with respect to the operator 701 while the hoist 100 is in vertical motion.

Although the hoist embodiment described herein may be used for transporting an internal combustion engine in a manufacturing environment, the hoist may advantageously be used to carry other loads in other for other applications. The ergonomic operation of the system reduces down time compared to traditional hoists. Power assisted motion of the hoist facilitates the operators to maneuver and position loads at a faster rate, thus decreasing cycle time for a transfer operation. Additionally, load manipulation is an easier operation that is more desirable to the operators.

The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A hoist comprising:
a lift assembly disposed on a horizontal support;
a support assembly;
a support arm disposed between the lift assembly and the support assembly;
an operator panel;
a support arm disposed between the support assembly and the operator panel;
wherein the operator panel is maintained at substantially the same height when the support assembly moves in a vertical direction.

2. The hoist of claim 1, wherein the support assembly is arranged and constructed to engage a load.

3. The hoist of claim 1, wherein the lift assembly engages in horizontal motion.

4. The hoist of claim 1, wherein the operator panel includes at least one handle, and wherein at least one control switch is disposed in the at least one handle.

5. The hoist of claim 4, further comprising a controller, wherein the at least one control switch is electronically coupled with the controller.

6. The hoist of claim 1, wherein the support assembly includes an upper support and a lower support, and wherein the lower support is rotateably connected to the upper support.

7. The hoist of claim 1, wherein the lift assembly includes at least one roller assembly, and wherein the at least one roller assembly is capable of powered motion.

8. The hoist of claim 1, wherein the at least one roller assembly includes a motor, and wherein the motor is controlled by a controller.

9. The hoist of claim 1, wherein a height of the operator panel is adjustable.

10. The hoist of claim 1, wherein the lift assembly is automatically alignable with a conveyor and wherein the operator can command the lift assembly to move past the conveyor.

11. A method comprising the steps of:
positioning a hoist over a load at a first position;
lowering the hoist to the first position while maintaining the operator panel at substantially a first height;
attaching the load to the hoist;
raising the hoist to a second position while maintaining the operator panel at substantially the first height;
moving the hoist carrying the load to a third position;
lowering the hoist to the third position while maintaining the operator panel at substantially the first height.

12. The method of claim 11, further comprising the step of rotating a support assembly disposed rotateably on the hoist.

13. The method of claim 11, wherein the first position is on a moving conveyor, and wherein the hoist automatically follows the conveyor.

14. The method of claim 11, wherein the third position is on a moving conveyor, and wherein the hoist automatically follows the conveyor.

15. The method of claim 11, further comprising the step of maintaining the operator panel at substantially the first height by adjusting a support arm between the operator panel and a support assembly for the hoist.

16. The method of claim 11, further comprising the step of adjusting the first height of the operator panel to suit an operator.

17. An ergonomic hoist comprising:
a lift assembly disposed on a horizontal support, wherein the lift assembly moves along the horizontal support utilizing a set of rollers;
a lift piston disposed between the lift assembly and a support assembly;
a support arm disposed between the support assembly and an operator panel such that the operator panel is maintainable at substantially one height while the support assembly moves in a vertical direction;
wherein the support assembly is movable along a major axis of the lift piston;
wherein the operator panel is moveable with respect to the support assembly;
wherein a height of the operator panel is adjustable.

18. The ergonomic hoist system of claim 17, further comprising at least one handle having at least one switch, wherein the at least one switch is connected to a controller, and wherein the handle has an ergonomic shape.

19. The ergonomic hoist system of claim 17, wherein a controller is capable of controlling a plurality of actuators, and wherein the actuators are capable of moving the ergonomic hoist system at least one of horizontally and vertically.

20. The ergonomic hoist system of claim 17, further comprising a load that is supported by the support assembly.

21. The ergonomic hoist system of claim 17, further comprising at least one handle operably associated with the operator panel, wherein the at least one handle has a dead-man switch disposed thereon.
